(19) United States
(12) Patent Application Publication
(10) Pub. No.: US 2026/0343144 A1
(43) Pub. Date: Oct. 29, 2026

(54) AUTOMATED ECHO CONTROL

(71) Applicant: QUALCOMM Incorporated, San Diego, CA (US)

(72) Inventors: Xing HU, Shenzhen (CN); Xiaoming BAO, Shanghai (CN); Jingbin WANG, Beijing (CN); Xia ZHAO, Beijing (CN)

(21) Appl. No.: 19/123,136

(22) PCT Filed: Nov. 9, 2022
(86) PCT No.: PCT/CN2022/130838

§ 371 Date: Apr. 22, 2025

(51) Int. Cl. H04R 3/02; G06F 3/16

(52) U.S. Cl. CPC H04R 3/02; G06F 3/162; G06F 3/165; H04R 2420/07

(57) ABSTRACT

A device includes one or more processors configured to detect a connection to an external device comprising a speaker. The one or more processors are also configured to transmit a signal to the external device. The signal instructs the external device to output a reference sound in an ultra-sound frequency range. The one or more processors are also configured to select a particular echo delay calculation process from among two or more echo calculation processes based at least on whether the reference sound is detected.

### I. FIELD

The present disclosure is generally related to automated echo control.

### II. DESCRIPTION OF RELATED ART

As audio processing becomes more ubiquitous and more advanced, users of audio products expect more accurate (and thus more realistic) audio processing when using computing devices to perform audio functions, such as voice calls.

Some audio products include echo cancelation systems to reduce echo that may be experienced during a voice call. Such echo can occur, for example, when audio captured at a near-end microphone is used to generate audio of a call. The audio of the call can be transmitted to a far-end device for playback and may also be played out at a near-end speaker. Audio output at the near-end speaker can be captured by the near-end microphone and reintroduced into the audio of the call, thus creating a cycle referred to as echo.

Many audio products use an echo cancelation process to reduce the effect of such echo. For example, the echo cancelation process may attempt to remove, from a signal sent to the far end, the near-end microphone signal audio components that are the result of output from a near-end speaker. For example, when a signal from the far end is sent to the near-end speaker for playout, a copy of the far-end signal can be delayed and subtracted from the audio captured by the microphone and sent to the far end. In this example, the delay applied before subtracting the copy of the far-end signal sent to the far end is based on an echo delay time between the near-end speaker and the near-end microphone. The echo delay time depends on a variety of factors and can vary based on communication protocols used, distance between the near-end speaker and the near-end microphone, etc. Inaccurate estimates of the echo delay time can result in a poor user experience.

### III. SUMMARY

In a particular aspect, a device includes one or more processors configured to detect a connection to an external device comprising a speaker. The one or more processors are also configured to transmit a signal to the external device, the signal instructing the external device to output a reference sound in an ultrasound frequency range. The one or more processors are also configured to select a particular echo delay calculation process from among two or more echo delay calculation processes based at least on whether the reference sound is detected.

In a particular aspect, a method includes detecting a connection to an external device comprising a speaker. The method also includes transmitting a signal to the external device, the signal instructing the external device to output a reference sound in an ultrasound frequency range. The method also includes selecting a particular echo delay calculation process from among two or more echo delay calculation processes based at least on whether the reference sound is detected.

In a particular aspect, a non-transient computer-readable medium stores instructions that when executed by a processor, cause the processor to detect a connection to an external device comprising a speaker. The instructions, when executed by the processor, also cause the processor to transmit a signal to the external device, the signal instructing the external device to output a reference sound in an ultrasound frequency range. The instructions, when executed by the processor, also cause the processor to select a particular echo delay calculation process from among two or more echo delay calculation processes based at least on whether the reference sound is detected.

In a particular aspect, an apparatus for communication includes means for detecting a connection to an external device comprising a speaker. The apparatus also includes means for transmitting a signal to the external device, the signal instructing the external device to output a reference sound in an ultrasound frequency range. The apparatus also includes means for selecting a particular echo delay calculation process from among two or more echo delay calculation processes based at least on whether the reference sound is detected.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system that includes a device that is configured to enable automated echo control, in accordance with some examples of the present disclosure.

FIG. 2 is a flow chart of an example of a method for enabling automated echo control, in accordance with some examples of the present disclosure.

FIG. 3 is a flow chart of another example of a method for enabling automated echo control, in accordance with some examples of the present disclosure.

FIG. 4 is a block diagram illustrating a particular example of the device of FIG. 1, in accordance with some examples of the subject disclosure.

FIG. 5 illustrates an example of an integrated circuit operable to enable automated echo control, in accordance with some examples of the present disclosure.

FIG. 6 illustrates a vehicle, illustrated as a car, that incorporates aspects of the device of FIG. 1, in accordance with some examples of the present disclosure.

FIG. 7 illustrates a headset that incorporates aspects of the device of FIG. 1, in accordance with some examples of the present disclosure.

FIG. 8 illustrates a wearable electronic device that incorporates aspects of the device of FIG. 1, in accordance with some examples of the present disclosure.

FIG. 9 illustrates a voice-controlled speaker system that incorporates aspects of the device of FIG. 1, in accordance with some examples of the present disclosure.

FIG. 10 illustrates a camera that incorporates aspects of the device of FIG. 1, in accordance with some examples of the present disclosure.

FIG. 11 illustrates a mobile device that incorporates aspects of the device of FIG. 1, in accordance with some examples of the present disclosure.

FIG. 12 illustrates another vehicle, illustrated as a manned or unmanned aerial device, that incorporates aspects of the device of FIG. 1, in accordance with some examples of the present disclosure.

FIG. 13 illustrates an extended reality headset that incorporates aspects of the device of FIG. 1, in accordance with some examples of the present disclosure.

### V. DETAILED DESCRIPTION

Systems and methods to enable automated echo control can take advantage of ultrasound-enabled devices to determine a more accurate echo delay time. By integrating the more accurate echo delay time into the echo cancelation process, the systems and methods disclosed herein can achieve improved automated echo control. For example, many current and future devices can be equipped to generate a reference sound in an ultrasound frequency range. An electronic device (e.g., a smart phone) can be configured to transmit a signal to an external device with a speaker (e.g., an external speaker), the signal instructing the external device to output the reference sound in the ultrasound frequency range.

If the external device is capable of generating the reference sound, and the electronic device receives the reference sound from the external device, the electronic device can select a particular echo delay calculation process from among two or more echo delay calculation processes, where the particular echo delay calculation process is configured to determine an echo path delay time from the electronic device to the speaker based on data associated with the received reference sound. An echo cancelation process can then use the echo path delay time as input to determine a more accurate echo cancelation parameter.

If the external device is not capable of generating the reference sound and/or the electronic device does not receive the reference sound, the electronic device can select a different echo delay calculation process from among the two or more echo delay calculation processes. For example, a trained model can be configured to determine an estimated echo delay time.

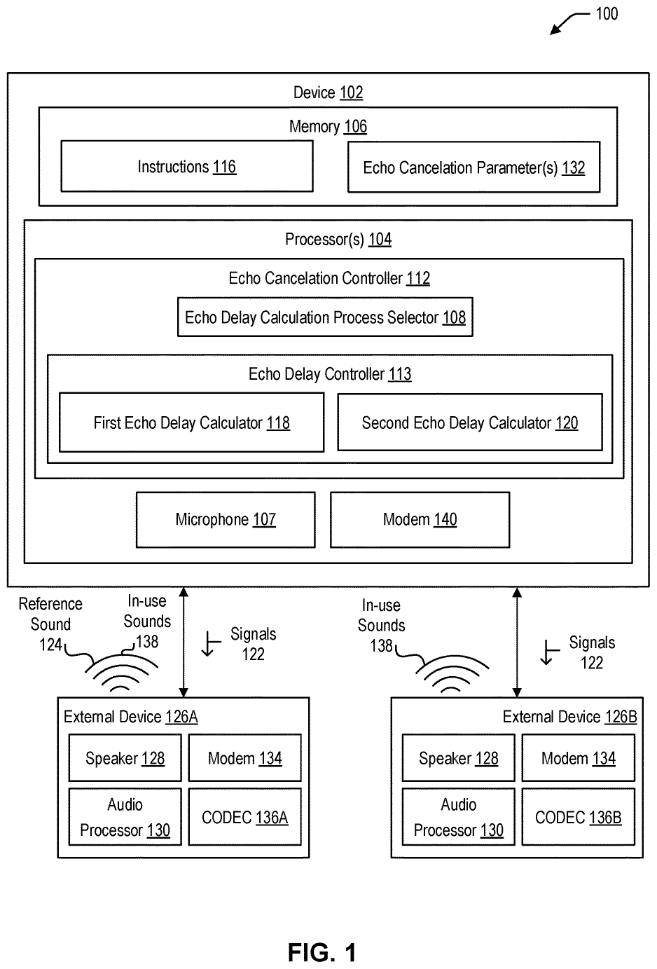

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 that includes one or more processors (e.g., processor(s) 104 in FIG. 1), which indicates that in some implementations the device 102 includes a single processor 104 and in other implementations the device 102 includes multiple processors 104. For ease of reference herein, such features are generally introduced as “one or more” features and are subsequently referred to in the singular or optional plural (generally indicated by terms ending in “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple external devices are illustrated and associated with reference numbers 126A and 126B. When referring to a particular one of these test points, such as the first external device 126A, the distinguishing letter “A” is used. However, when referring to any arbitrary one of these external devices or to external devices as a group, the reference number 126 is used without a distinguishing letter.

The terms “comprise,” “comprises,” and “comprising” are used herein interchangeably with “include,” “includes,” or “including.” Additionally, the term “wherein” is used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” refers to two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data. Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

FIG. 1 is a block diagram of an example of a system 100 that includes a device 102 that is configured to enable automated echo control, in accordance with some examples of the present disclosure. In some implementations, the device 102 includes one or more processors 104 coupled to a memory 106 storing instructions 116 for execution by the processor(s) 104. The processor(s) 104 are configured to detect a connection to an external device 126 including a speaker 128, as described in more detail below. The processor(s) 104 are also configured to transmit signals 122 to the external device 126. The signals 122 can include audio data representing sounds to be output by the speaker 128 of the external device 126. For example, the sounds can include far-end speech during a voice call. As another example, during configuration of an echo cancelation process, the signals 122 may instruct the external device 126 to output a reference sound 124 in an ultrasound frequency range, as described in more detail below. The processor(s) 104 are also configured to select a particular echo delay calculation process from among two or more echo delay calculation processes based at least on whether the reference sound 124 is detected, as described in more detail below.

In some implementations, the device 102 includes or corresponds to an electronic device including the processor(s) 104 coupled to the memory 106. For example, the device 102 can include a voice activated device, an audio device, a wireless speaker and voice activated device, a portable electronic device, a car, a vehicle, a computing device, a communication device, an internet-of-things (IoT) device, a virtual reality (VR) device, an augmented reality (AR) device, a mixed reality (MR) device, a smart speaker, a mobile computing device, a mobile communication device, a smart phone, a cellular phone, a laptop computer, a computer, a tablet, a personal digital assistant, a display device, a television, a gaming console, an appliance, a music player, a radio, a digital video player, a digital video disc (DVD) player, a tuner, a camera, a navigation device, any other appropriate electronic device that can support a voice and/or voice over internet protocol (“VOIP”) call with a microphone and external speaker, or some combination thereof.

In some implementations, the processor(s) 104 are configured to detect a connection to the external device 126. The external device 126 can include an electronic device including the speaker 128. For example, the external device 126 can include another electronic device; a portable speaker; an external, non-portable speaker; an electronic device configured to output audio (e.g., an electronic device incorporated into another device such as a vehicle, virtual and/or extended reality device, smart speaker, camera, wearable electronic device, unmanned aerial vehicle, etc.); or some combination thereof.

In a particular aspect, the connection between the device 102 and the external device 126 can include a high-definition multimedia interface (“HDMI”) connection. In a particular aspect, the processor(s) 104 can be configured to detect that the device 102 has been coupled to the external device 126 via an HDMI connection. With the illustrative example of an HDMI connection, the echo path delay can range from a few milliseconds to hundreds of milliseconds, depending on the nature of the external device 126, the device 102, the quality of the connection, the particular HDMI codec implemented at the external device 126, environmental factors, etc.

Some systems perform echo cancelation operations using preconfigured and/or preset delay values. However, when the speaker 128 is part of the external device 126 (rather than integrated within the device 102), the echo delay path can vary over a relatively large range of values. As such, preconfigured and/or preset delay values may be ineffective to accurately reduce echo. As an illustrative example, a device coupled via an HDMI connection to an external speaker can be configured to use a default echo delay value of twenty milliseconds for echo cancelation during a call. If the real echo delay over the HDMI connection is 200 milliseconds, the echo path delay process will have an initial error of 180 milliseconds. This can lead to echo residual issues at the far end of the call.

In the same or alternative particular aspects, the device 102 can be coupled to the external device 126 by another type of connection. In a particular aspect, the device 102 can be coupled to the external device 126 via a wireless connection. For example, the wireless connection can include a Bluetooth® connection, a Wi-Fi® connection, or a combination thereof (Bluetooth is a registered trademark of the Bluetooth Special Interest Group, and Wi-Fi is a registered trademark of the Wi-Fi Alliance).

In some implementations, the processor(s) 104 are configured to cause a modem 140 to transmit the signals 122 to the external device 126. The signals 122 can include, for example, audio data representing far-end audio or instructions to cause the external device 126 to output the reference sound 124 in an ultrasound frequency range. In some aspects, the external device 126 includes a modem 134 configured to receive the signals 122 from the device 102. The modem 134 can be configured to communicate some or all of the signals 122 to an audio processor 130 of the external device 126 for processing by one or more audio codecs 136.

In some implementations, the audio codec(s) 136 are configured to decode the signals 122 to generate audio for output by the speaker 128 of the external device 126. For example, the audio codec(s) 136 are configured to generate analog audio signals associated with a voice call. The speaker 128 can be configured to convert these signals to sound. In some aspects, one or more of the codecs 136 of the external device 126 are configured to decode the signals 122 to generate the reference sound 124. In the same or alternative aspects, one or more of the codecs 136 of the external device 126 are configured to receive the signals 122 but are incapable of generating the reference sound 124. For example, a particular codec is not configured to decode particular types of signals (e.g., signals representing ultrasound), is not configured to generate audio signals associated with ultrasound, or some combination thereof.

FIG. 1 illustrates two examples of the external device 126, including a first exemplary external device 126A and a second exemplary external device 126B. The first exemplary external device 126A includes a particular codec 136A that is configured to decode the signals 122 sent by the device 102 to output a reference sound 124 (e.g., during a set-up process) and to decode the signals 122 sent by the device 102 to output in-use sounds 138 (e.g., during a call). The reference sound 124 includes, for example, a sound in an ultrasound frequency range that is used by the device 102 to determine echo path delay. The in-use sounds 138 may include, for example, far-end audio received by the device 102 from a remote device during a call. To illustrate, speech of a far-end user of a call may be played out via the speaker 128 (as in-use sounds 138) for consumption by a near-end user of the call.

In the example illustrated in FIG. 1, the second exemplary external device 126B includes a particular codec 136B that is not operable to generate the reference sound 124. Thus, the second exemplary external device 126B is illustrated as outputting the in-use sounds 138, but not the reference sound 124.

A microphone 107 of the device 102 is configured to generate audio data representing a near-end audio environment of the device 102. For example, the audio data may include data associated with speech of a near-end user during a voice call. During the voice call, the audio data representing the near-end audio environment is transmitted to a far-end device (e.g., via voice-over Internet protocol packets). The sound captured by the microphone 107 during the voice call can include audio output by the external device 126, such as the in-use sounds 138 as well as other sounds in the near-end audio environment.

For example, during the voice call, in addition to capturing speech of the near-end user, the microphone 107 may capture some or all of the in-use sounds 138 output by the speaker 128. In this example, if the in-use sounds 138 include components based on far-end audio, an echo cancelation controller 112 of the device 102 attempts to remove the components based on far-end audio from the audio data transmitted to the far end to reduce echo experienced at the far end.

In some implementations, the processor(s) 104 can be configured to select a particular echo delay calculation process from among two or more echo delay calculation processes based at least on whether the reference sound 124 is detected. In some aspects, the echo cancelation controller 112 includes an echo delay calculation process selector 108 configured to select the particular echo delay calculation process from among two or more echo delay calculation processes. In a particular aspect, the echo cancelation controller 112 also includes an echo delay controller 113 that includes a first echo delay calculator 118 and a second echo delay calculator 120. The first echo delay calculator 118 is configured to determine a first echo delay time using the first echo delay calculation process, and the second echo delay calculator 120 is configured to determine a second echo delay time using the second echo delay calculation process. For example, the echo delay calculation process selector 108 can select the first echo delay calculation process responsive to receipt of the reference sound 124 from the external device 126 and/or select the second echo delay calculation process responsive to not receiving the reference sound 124 from the external device 126.

In some implementations, the processor(s) 104 are configured to communicate data associated with the received reference sound 124 to the echo cancelation controller 112. For example, the processor(s) 104 may be configured to communicate data indicative of an amount of time elapsed from generation of a signal 122 instructing the external device 126 to output the reference sound 124 to receipt of the reference sound 124 at the microphone 107. As an additional example, the processor(s) 104 can be configured to communicate data indicative of a signal strength or other parameter(s) associated with the received reference sound 124.

In a particular aspect, the first echo delay calculator 118 is configured to, based at least on data associated with the received reference sound 124, determine an echo path delay time between the device 102 and the speaker 128. In the same or alternative particular aspects, the second echo delay calculator 120 is configured to estimate the echo delay responsive to the device 102 not receiving the reference sound 124 from the external device 126. For example, the second echo delay calculator 120 may use a trained model of one or more trained models to determine an estimated echo delay time. In this example, the device 102 can also include the one or more trained models.

In some implementations, the processor(s) 104 are configured to provide the echo path delay time from the first echo delay calculator 118, the estimated echo delay time from the second echo delay calculator 120, or both, as input to an echo cancelation process. In some aspects, the echo cancelation process can include a second trained model of the one or more trained models. In a particular aspect, the second trained model can be configured to determine one or more echo cancelation parameters 132 based on the echo path delay time, the estimated echo delay time, or both. The echo cancelation parameter(s) 132 can include, for example, an echo cancelation time. In this example, the echo cancelation time indicates a delay between receipt of particular audio from the far end and removal of audio components based on the particular audio from audio data generated by the microphone 107. As another example, the echo cancelation parameter(s) 132 can include other parameters associated with echo cancelation, such as an attenuation value associated with the buffered audio data for use in echo cancelation.

In operation, the device 102 is operable to subtract components of far-end audio from audio data captured by the microphone 107 to reduce echo at the far end due to the device 102 using the external device 126 to output audio from the far end. For example, during a call, the microphone 107 captures near-end audio, which may include components of far-end audio that are present in the in-use sounds 138. In this example, the echo cancelation controller 112 performs echo cancelation operations to modify the near-end audio to remove the far-end audio components. To illustrate, the echo cancelation controller 112 buffers audio from the far end for a period corresponding to the echo cancelation time and then subtracts the far-end audio from the near-end audio. The echo cancelation time is determined (e.g., based on output of the first echo delay calculator 118 and/or the second echo delay calculator 120) such that the buffered far-end audio is subtracted from the portion of the near-end audio data that includes the far-end audio components present in the in-use sounds 138.

If the external device 126 is able to output the reference sound 124, the first echo delay calculator 118 can calculate a highly accurate echo path delay time using a relatively efficient (in terms of computing resources used) process. Further, since the reference sound 124 is inaudible to users, the external device 126 can output the reference sound 124 without disturbing users at the near end. To illustrate, the users at the near end may be unaware that the external device 126 output the reference sound 124 during set up of a call or at the beginning of the call. However, if the external device 126 is not able to output the reference sound 124, or for some other reason the device 102 does not receive the reference sound 124 from the external device 126, the second echo delay calculator 120 can estimate echo path delay time using a trained machine-learning model. The estimated echo delay time generated by the trained machine-learning model can be as accurate as the echo path delay time determined by the first echo delay calculator 118; however, determining the estimated echo delay time using the trained machine-learning model is slightly less efficient (in terms of computing resources used) and may take time to converge to an acceptable echo delay time estimate. Before the trained machine-learning model converges to an acceptable echo delay time estimate, far-end users may experience some echo.

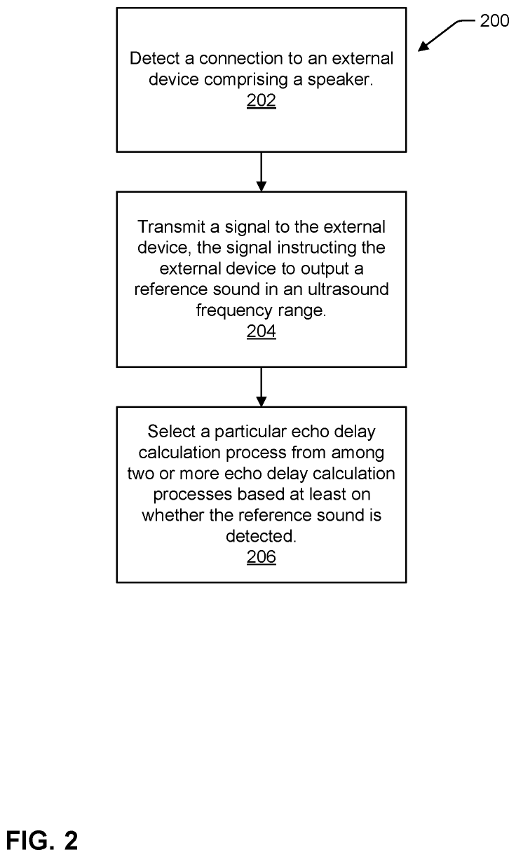

FIG. 2 is a flow chart of an example of a method 200 for enabling automated echo control, in accordance with some examples of the present disclosure. The method 200 may be initiated, performed, or controlled by one or more processors executing instructions, such as by the processor(s) 104 of FIG. 1 executing instructions from the memory 106.

In some implementations, the method 200 can optionally include, at block 202, detecting a connection to an external device comprising a speaker. For example, the processor(s) 104 of FIG. 1 can detect the connection to one or both of the external device(s) 126 including the speaker 128, as described in more detail above with reference to FIG. 1.

In the example of FIG. 2, the method 200 can optionally include, at block 204, transmitting a signal to the external device, the signal instructing the external device to output a reference sound in an ultrasound frequency range. For example, the processor(s) 104 of FIG. 1 can transmit the signals 122 to the external device(s) 126, and the signals 122 may instruct the external device(s) 126 to output the reference sound 124 in an ultrasound frequency range (e.g., 20-22 kHz).

In the example of FIG. 2, the method 200 can optionally include, at block 206, selecting a particular echo delay calculation process from among two or more echo delay calculation processes based at least on whether the reference sound is detected. For example, the processor(s) 104 of FIG. 1 can select a particular echo delay calculation process from between the first echo delay calculation process and the second echo delay calculation process based at least on whether the reference sound 124 is detected.

Although the method 200 is illustrated as including a certain number of operations, more, fewer, and/or different operations can be included in the method 200 without departing from the scope of the subject disclosure. For example, the method 200 can include selecting a particular echo delay calculation process from more than the first echo delay calculation process and the second echo delay calculation process. As an additional example, the method 200 can vary depending on the number of external device(s) 126 coupled to the device 102.

In some implementations, the method 200 can repeat the operations of one or more of blocks 202-206 periodically, occasionally, and/or continuously. For example, the method 200 can attempt to detect the connection to the external device(s) 126 periodically (e.g., every few milliseconds) to account for new connections. As an additional example, the method 200 can transmit the signals 122 instructing the external device(s) 126 to output the reference sound 124 more than once (e.g., multiple times before the second echo delay calculator 120 converges to an acceptable echo path delay estimate) to attempt to account for modifications to the connection between the device 102 and the external device(s) 126, miscommunication, etc.

Further, although the examples provided above in illustrating method 200 include the processor(s) 104 of FIG. 1 performing operations of the method 200, some or all of the operations of the method 200 can be performed by any suitable computing device. For example, selecting the particular echo delay calculation process from among two or more echo delay calculation processes based at least on whether the reference sound is detected (e.g., as described above with reference to block 206) can be performed by one or more servers in communication with the processor(s) 104 of FIG. 1.

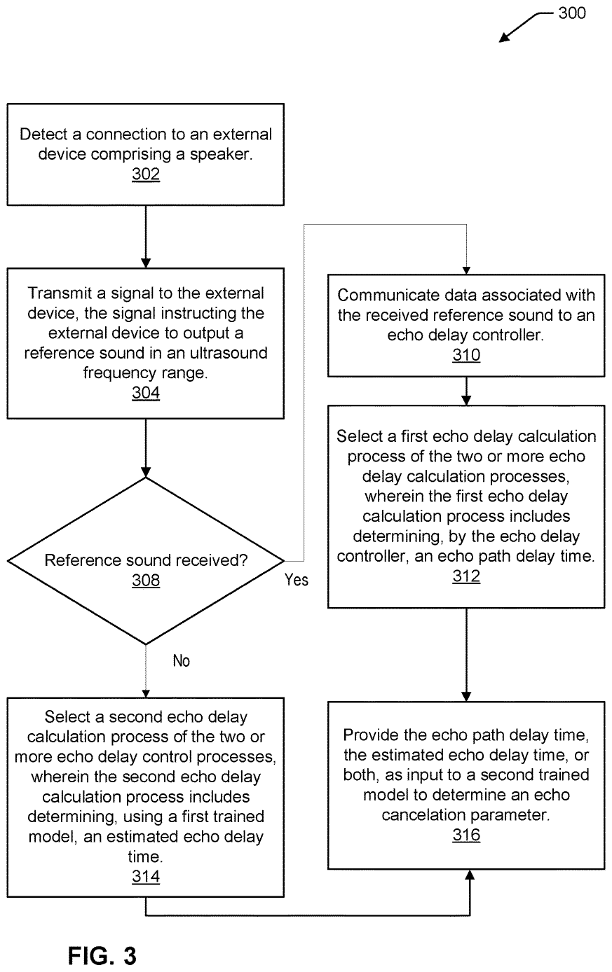

FIG. 3 is a flow chart of another example of a method 300 for enabling automated echo control, in accordance with some examples of the present disclosure. The method 300 may be initiated, performed, or controlled by one or more processors executing instructions, such as by the processor(s) 104 of FIG. 1 executing instructions from the memory 106.

In the example of FIG. 3, the method 300 can optionally include, at block 302, detecting a connection to an external device comprising a speaker. For example, the processor(s) 104 of FIG. 1 can detect a connection to one or more of the external device(s) 126 including the speaker 128.

In the example of FIG. 3, the method 300 can optionally include, at block 304, transmitting a signal to the external device, where the signal instructs the external device to output a reference sound in an ultrasound frequency range. For example, the processor(s) 104 of FIG. 1 can transmit the signals 122 to one or more of the external device(s) 126. In this example, the signals 122 instruct the external device(s) 126 to output the reference sound 124 in an ultrasound frequency range (e.g., 20-22 kHz).

In the example of FIG. 3, the method 300 can optionally include, at block 308, determining whether a reference sound was received. For example, the processor(s) 104 of FIG. 1 can determine whether the reference sound 124 was received at the device 102 from the external device(s) 126. Responsive to receipt of the reference sound, the method 300 can proceed to block 310, where the method 300 includes communicating data associated with the received reference sound to an echo delay controller. For example, the processor(s) 104 of FIG. 1 can be configured to communicate data associated with the received reference sound 124 to the echo delay controller 113 if the device 102 receives the reference sound 124.

After communicating data associated with the received reference sound to an echo delay controller, the method 300 can optionally include, at block 312, selecting a first echo delay calculation process of the two or more echo delay calculation processes, wherein the first echo delay calculation process includes determining, by the echo delay controller, an echo path delay time. For example, the processor(s) 104 of FIG. 1 can be configured to select the first echo delay calculation process of the two or more echo delay calculation processes (e.g., the first echo delay calculation process and the second echo delay calculation process), wherein the first echo delay calculation process includes determining, by the echo delay controller 113, an echo path delay time for the external device 126 After selecting the first echo delay calculation process, the method 300 can optionally proceed to 316, as described in more detail below.

Referring again to block 308, responsive to not receiving the reference sound 124 from the external device, the method 300 can optionally include, at block 314, selecting a second echo delay calculation process of the two or more echo delay calculation processes, wherein the second echo delay calculation process includes determining, using a trained model, an estimated echo delay time. For example, the processor(s) 104 of FIG. 1 can be configured to select the second echo delay calculation process of the two or more echo delay calculation processes, wherein the second echo delay calculation process includes determining, using the trained model, an estimated echo delay time. After selecting the second echo delay calculation process, the method 300 can optionally proceed to 316.

In the example of FIG. 3, the method 300 includes, at block 316, providing the echo path delay time, the estimated echo delay time, or both, as input to a second trained model to determine an echo cancelation parameter. For example, the processor(s) 104 of FIG. 1 can be configured to provide the echo path delay time, the estimated echo delay time, or both, as input to the second trained model to determine the echo cancelation parameter(s) 132.

Although the method 300 is illustrated as including a certain number of operations, more, fewer, and/or different operations can be included in the method 300 without departing from the scope of the subject disclosure. For example, the method 300 can include selecting a particular echo delay calculation process from more than the first echo delay calculation process and the second echo delay calculation process. As an additional example, the method 300 can vary depending on the number of external device(s) 126 coupled to the device 102.

In some implementations, the method 300 can repeat the operations of one or more of blocks 302-316 periodically, occasionally, and/or continuously. For example, the method 300 can attempt to detect the connection to the external device(s) 126 every few milliseconds to account for new connections. As an additional example, the method 300 can attempt to transmit the signals 122 every few milliseconds to account for modifications to the connection between the device 102 and the external device(s) 126, miscommunication, etc.

Further, although the examples provided above in illustrating method 300 include the processor(s) 104 of FIG. 1 performing operations of the method 300, some or all of the operations of the method 300 can be performed by any suitable computing device. For example, selecting the particular echo delay calculation process from among two or more echo delay calculation processes based at least on whether the reference sound is detected (e.g., as described above with reference to blocks 308, 310, 314) can be performed by one or more servers in communication with the processor(s) 104 of FIG. 1.

Although the examples provided above describe the processor(s) 104 of FIG. 1 performing the operations of the methods 200, 300 of FIGS. 2-3, as well as the various operations described in FIGS. 1-13, some or all of the operations can be performed by any suitable computing device. For example, the first echo delay calculation process and the second echo delay calculation process can be performed by separate computing devices.

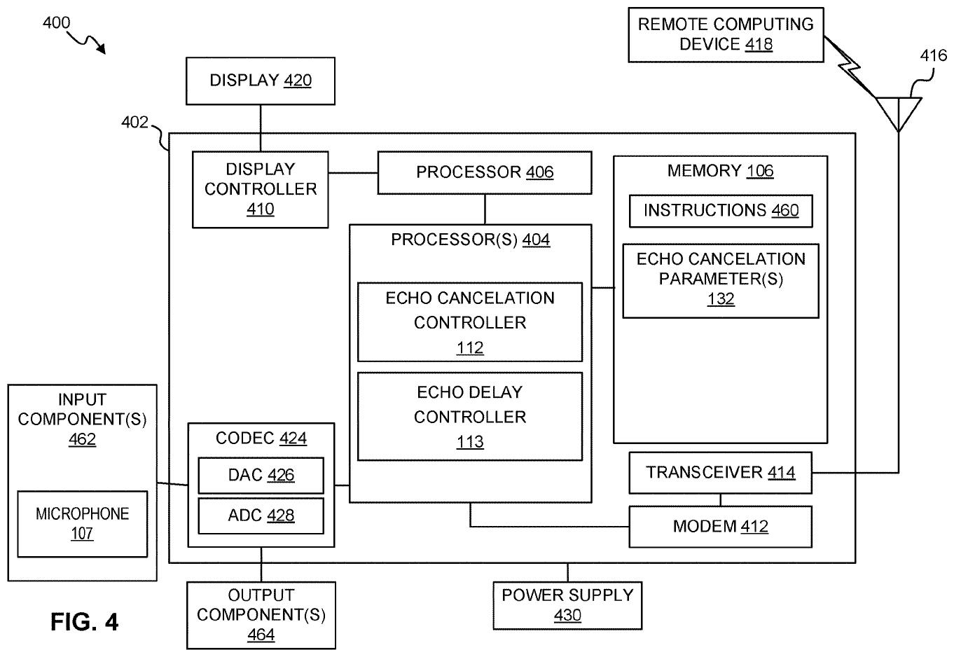

FIG. 4 is a block diagram illustrating a particular example 400 of the device 102 of FIG. 1, in accordance with some examples of the subject disclosure. In various implementations, the device 102 may have more or fewer components than illustrated in FIG. 4.

In a particular implementation, the device 102 includes a processor 404 (e.g., a central processing unit (CPU)). The device 102 may include one or more additional processor(s) 406 (e.g., one or more digital signal processors (DSPs)). The processor 404, the additional processor(s) 406, or both, may correspond to the one or more processors 104 of FIG. 1. For example, in FIG. 4, the processor(s) 404 include the echo delay controller 113, the echo cancelation controller 112, or a combination thereof.

In FIG. 4, the device 402 also includes the memory 106 and a CODEC 424. The memory 106 can include a non-transient, computer-readable medium that stores instructions 460 that are executable by the processor 404, and/or the additional processor(s) 406, to implement one or more operations described with reference to FIGS. 1-3. In an example, the memory 106 corresponds to a non-transitory computer-readable medium that stores the instructions 460 executable by the one or more processors 404, and the instructions 460 include or correspond to (e.g., are executable by a processor to perform operations attributed to) the echo cancelation controller 112, the echo delay controller 113, the one or more trained models, or a combination thereof. The memory 106 may also store the echo cancelation parameter(s) 132 of FIG. 1.

In FIG. 4, the input component(s) 462, including in some configurations the microphone 107 of FIG. 1, and/or the output component(s) 464 may be coupled to the CODEC 424. In the example illustrated in FIG. 4, the CODEC 424 includes a digital-to-analog converter (DAC 426) and an analog-to-digital converter (ADC 428). In a particular implementation, the CODEC 424 receives analog signals from the input component(s) 462 (e.g., the reference sound 124), converts the analog signals to digital signals using the ADC 428, and provides the digital signals to the processor(s) 404. In a particular implementation, the processor(s) 404 provide digital signals to the CODEC 424, and the CODEC 424 converts the digital signals to analog signals using the DAC 426 and provides the analog signals to the output component(s) 464.

In FIG. 4, the device 402 also includes a display 420 coupled to a display controller 410. In some implementations, the device 402 also includes a modem 412 coupled to a transceiver 414. In FIG. 4, the transceiver 414 is coupled to an antenna 416 to enable wireless communication with other devices, such as the remote computing device 418 (e.g., the external device(s) 126). In other examples, the transceiver 414 is also, or alternatively, coupled to a communication port (e.g., an ethernet port) to enable wired communication with other devices, such as the remote computing device 418.

In a particular implementation, the device 402 is included in a system-in-package or system-on-chip device 402. In a particular implementation, the memory 106, the processor 404, the additional processor(s) 406, the display controller 410, the CODEC 424, the modem 412, and the transceiver 414 are included in the system-in-package or system-on-chip device 402. In a particular implementation, a power supply 430 is coupled to the system-in-package or system-on-chip device 402. Moreover, in a particular implementation, as illustrated in FIG. 4, the display 420, the input component(s) 462, the output component(s) 464, the antenna 416, and the power supply 430 are external to the system-in-package or system-on-chip device 402. In a particular implementation, each of the display 420, the input component(s) 462, the output component(s) 464, the antenna 416, and the power supply 430 may be coupled to a component of the system-in-package or system-on-chip device 402, such as an interface or a controller.

The device 402 may include, correspond to, or be included within a voice activated device, an audio device, a wireless speaker and voice activated device, a portable electronic device, a car, a vehicle, a computing device, a communication device, an internet-of-things (IoT) device, a virtual reality (VR) device, an augmented reality (AR) device, a mixed reality (MR) device, a smart speaker, a mobile computing device, a mobile communication device, a smart phone, a cellular phone, a laptop computer, a computer, a tablet, a personal digital assistant, a display device, a television, a gaming console, an appliance, a music player, a radio, a digital video player, a digital video disc (DVD) player, a tuner, a camera, a navigation device, or any combination thereof. In a particular aspect, the processor 404, the additional processor(s) 406, or a combination thereof, are included in an integrated circuit.

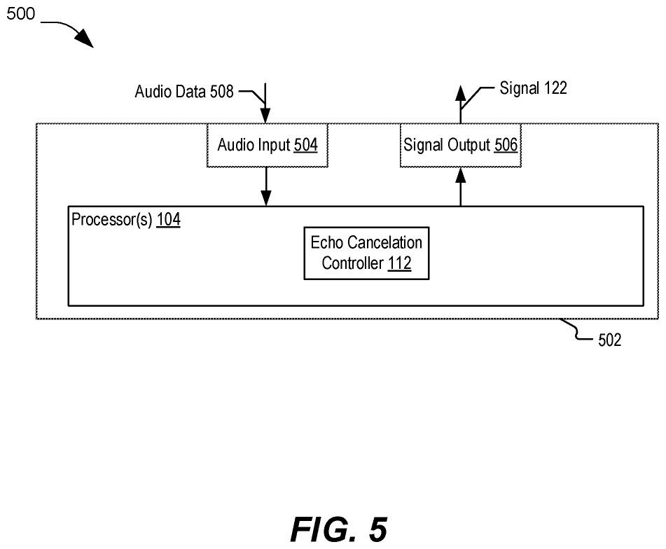

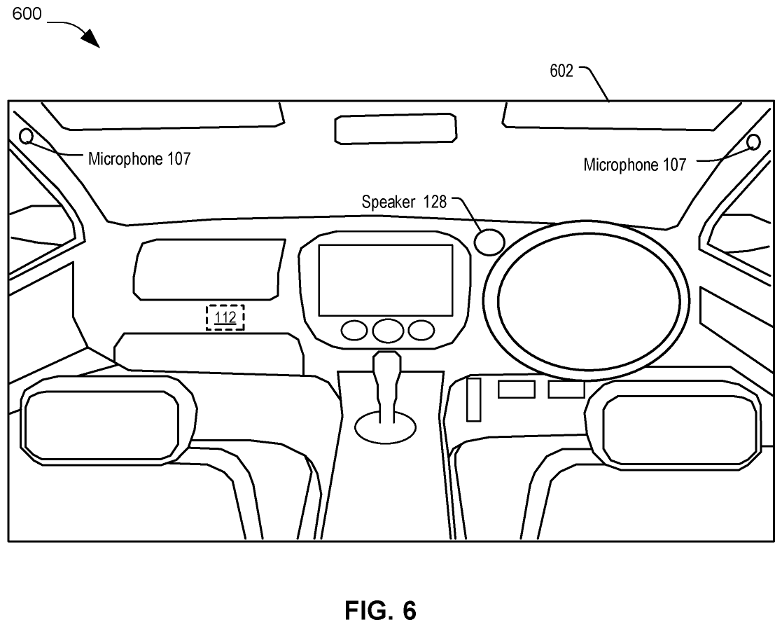

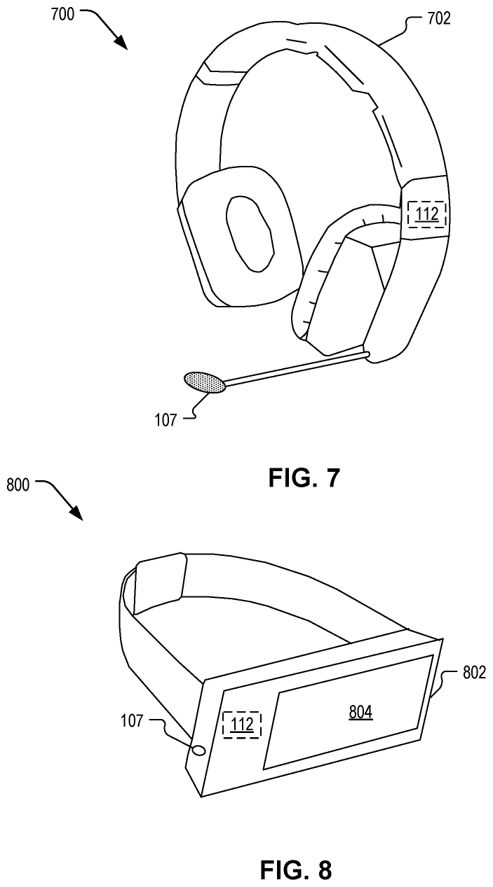

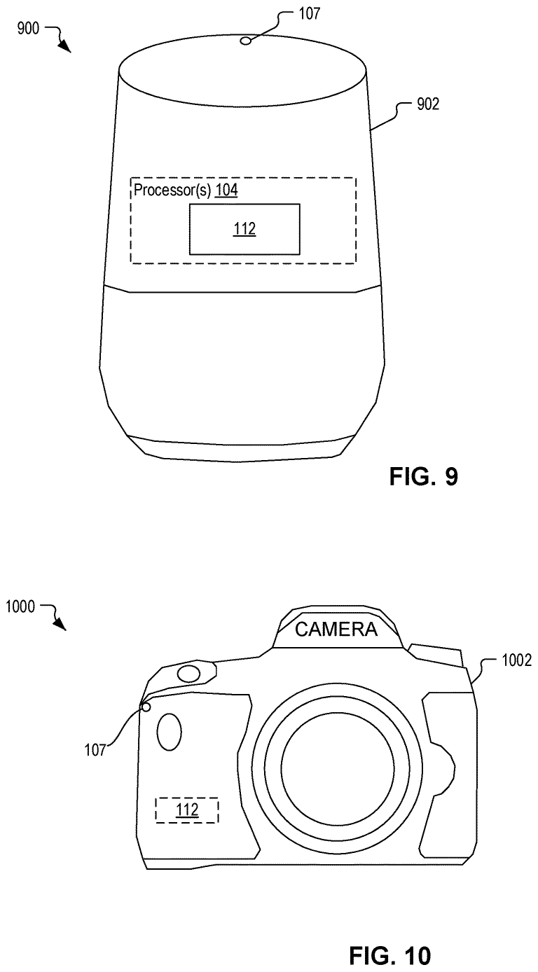

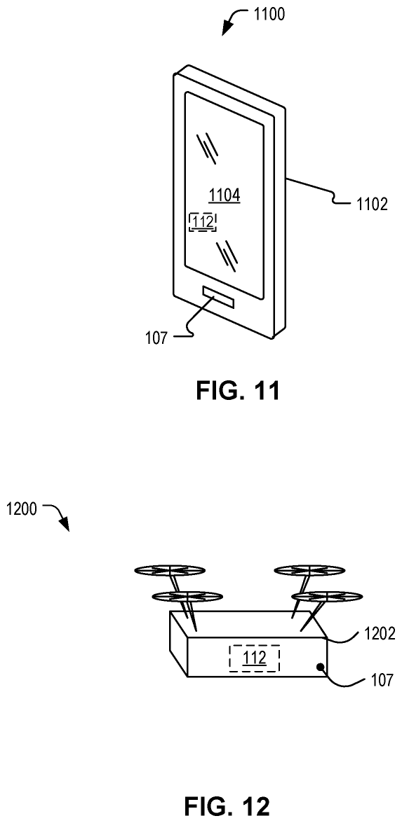

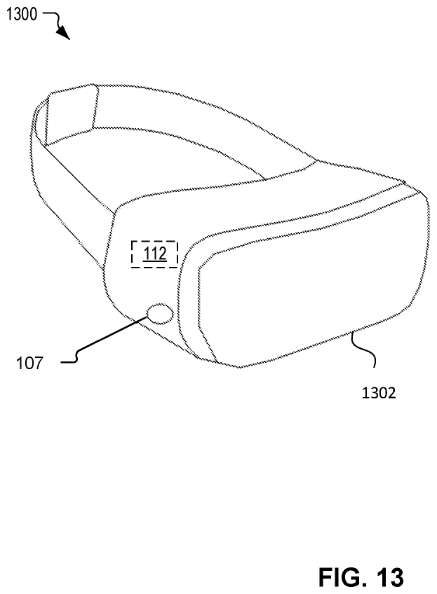

FIG. 5 illustrates an example of an integrated circuit operable to enable automated echo control, in accordance with some examples of the present disclosure. FIG. 5 depicts an implementation 500 of the device 102 as an integrated circuit 502 that includes the one or more processors 104, which can, in some implementations, include the echo cancelation controller 112 of FIG. 1. The integrated circuit 502 also includes an audio input 504, such as one or more bus interfaces, to enable audio data 508 to be received for processing. In some implementations, the audio data 508 is data associated with the reference sound 124, the in-use sounds 138, or some combination thereof, received by the device 102 via the microphone 107. Additionally, during a call, the audio data 508 may include far-end audio of the call. The integrated circuit 502 also includes a signal output 506, such as a bus interface, to enable sending of an output signal, such as the signals 122. The integrated circuit 502 enables implementation of improved automated echo control as a component in a system that includes microphones, such as a mobile phone or tablet as depicted in FIG. 11, a headset as depicted in FIG. 7, a wearable electronic device as depicted in FIG. 8, a voice-controlled speaker system as depicted in FIG. 9, a camera as depicted in FIG. 10, a virtual reality, mixed reality, or augmented reality headset as depicted in FIG. 13, or a vehicle as depicted in FIG. 6 or FIG. 12.

FIG. 6 illustrates an implementation 600 in which the device 102 corresponds to, or is integrated within, a vehicle 602, illustrated as a car. In some aspects, one or more processor(s) (e.g., the processor(s) 104 of FIG. 1), which include the echo cancelation controller 112, are integrated in the vehicle 602. The vehicle 602 also includes the microphone 107. The microphone 107 is positioned to capture near-end audio from an operator of the vehicle 602, a passenger of the vehicle 602, an external device within, integrated into, or in proximity to the vehicle 602, or some combination thereof. During operation, the microphone 107 may capture sound within the vehicle 602, which may include the reference sound 124 of FIG. 1 from an external device, the in-use sounds 138 from an external device, or some combination thereof. The echo cancelation controller 112 may select a particular echo delay calculation process based at least on whether the reference sound 124 is detected.

In the same or alternative aspects, the vehicle 602 can be configured to act as the external device 126 coupled to an electronic device (e.g., the device 102 of FIG. 1 or another device as described below with reference to FIGS. 7-13). For example, the vehicle 602 can include the speaker 128 to generate the reference sound 124 of FIG. 1, the in-use sounds 138, or some combination thereof.

FIG. 7 depicts an implementation 700 in which the device 102 includes a headset device 702. The headset device 702 includes the microphone 107. Components of the processor(s) 104 of FIG. 1, including the echo cancelation controller 112, are integrated in the headset device 702. In a particular example, the echo cancelation controller 112 operates to select a particular echo delay calculation process from among two or more echo delay calculation processes based at least on whether the reference sound is detected. For example, the microphone 107 may capture speech of a user of the headset device 702, an external device within, integrated into, or in proximity to the headset device 702, or some combination thereof. The echo cancelation controller 112 may select a particular echo delay process based at least on whether the reference sound 124 of FIG. 1 is detected.

FIG. 8 depicts an implementation 800 in which the device 102 includes a wearable electronic device 802, illustrated as a “smart watch.” The wearable electronic device 802 includes the microphone 107. Components of the processor(s) 104 of FIG. 1, including the echo cancelation controller 112, are integrated in the wearable electronic device 802. The wearable electronic device 802 also includes a display screen 804. In a particular example, the echo cancelation controller 112 operates to select a particular echo delay calculation process from among two or more echo delay calculation processes based at least on whether the reference sound is detected. For example, the microphone 107 may capture speech of a user of the wearable electronic device 802, an external device within, integrated into, or in proximity to the wearable electronic device 802, or some combination thereof. The echo cancelation controller 112 may select a particular echo delay process based at least on whether the reference sound 124 of FIG. 1 is detected.

In the same or alternative aspects, the wearable electronic device 802 can be configured to act as the external device 126 coupled to an electronic device (e.g., another device as described with reference to FIGS. 6-7, 9-13). For example, the wearable electronic device 802 can include the speaker 128 to generate the reference sound 124 of FIG. 1, the in-use sounds 138, or some combination thereof.

FIG. 9 is an implementation 900 in which the device 102 includes a wireless speaker and voice activated device 902. The wireless speaker and voice activated device 902 can have wireless network connectivity and is configured to execute an assistant operation. The wireless speaker and voice activated device 902 of FIG. 9 includes the processor(s) 104 of FIG. 1, which includes the echo cancelation controller 112. Additionally, the wireless speaker and voice activated device 902 includes the microphone 107. In a particular example, the echo cancelation controller 112 operates to select a particular echo delay calculation process from among two or more echo delay calculation processes based at least on whether the reference sound is detected. For example, the microphone 107 may capture speech of a user of the wireless speaker and voice activated device 902, an external device within, integrated into, or in proximity to the wireless speaker and voice activated device 902, or some combination thereof. The echo cancelation controller 112 may select a particular echo delay process based at least on whether the reference sound 124 of FIG. 1 is detected.

In the same or alternative aspects, the wireless speaker and voice activated device 902 can be configured to act as the external device 126 coupled to an electronic device (e.g., another device as described with reference to FIGS. 6-8, 10-13). For example, the wireless speaker and voice activated device 902 can include the speaker 128 to generate the reference sound 124 of FIG. 1, the in-use sounds 138, or some combination thereof.

FIG. 10 depicts an implementation 1000 in which the device 102 is integrated into or includes a portable electronic device that corresponds to a camera 1002. In FIG. 10, the camera 1002 includes the microphone 107. Components of the processor(s) 104 of FIG. 1, including the echo cancelation controller 112, are integrated in the camera 1002. In a particular example, the echo cancelation controller 112 operates to select a particular echo delay calculation process from among two or more echo delay calculation processes based at least on whether the reference sound is detected. For example, the microphone 107 may capture speech of a user of the camera 1002, an external device within, integrated into, or in proximity to the camera 1002, or some combination thereof. The echo cancelation controller 112 may select a particular echo delay process based at least on whether the reference sound 124 of FIG. 1 is detected.

In the same or alternative aspects, the camera 1002 can be configured to act as the external device 126 coupled to an electronic device (e.g., another device as described with reference to FIGS. 6-9, 11-13). For example, the camera 1002 can include the speaker 128 to generate the reference sound 124 of FIG. 1, the in-use sounds 138, or some combination thereof.

FIG. 11 depicts an implementation 1100 in which the device 102 includes a mobile device 1102, such as a phone or tablet, as illustrative, non-limiting examples. The mobile device 1102 includes the microphone 107 and a display screen 1104. Components of the processor(s) 104 of FIG. 1, including the echo cancelation controller 112, are integrated in the mobile device 1102. In a particular example, the echo cancelation controller 112 operates to select a particular echo delay calculation process from among two or more echo delay calculation processes based at least on whether the reference sound is detected. For example, the microphone 107 may capture speech of a user of the mobile device 1102, an external device within, integrated into, or in proximity to the mobile device 1102, or some combination thereof. The echo cancelation controller 112 may select a particular echo delay process based at least on whether the reference sound 124 of FIG. 1 is detected.

In the same or alternative aspects, the mobile device 1102 can be configured to act as the external device 126 coupled to an electronic device (e.g., another device as described with reference to FIGS. 6-10, 12-13). For example, the mobile device 1102 can include the speaker 128 to generate the reference sound 124 of FIG. 1, the in-use sounds 138, or some combination thereof.

FIG. 12 depicts an implementation 1200 in which the device 102 corresponds to, or is integrated within, a vehicle 1202, illustrated as a manned or unmanned aerial device (e.g., a package delivery drone). The vehicle 1202 includes the microphone 107. Components of the processor(s) 104 of FIG. 1, including the echo cancelation controller 112, are integrated in the vehicle 1202. In a particular example, the echo cancelation controller 112 operates to select a particular echo delay calculation process from among two or more echo delay calculation processes based at least on whether the reference sound is detected. For example, the microphone 107 may capture speech of a user of the vehicle 1202, an external device within, integrated into, or in proximity to the vehicle 1202, or some combination thereof. The echo cancelation controller 112 may select a particular echo delay process based at least on whether the reference sound 124 of FIG. 1 is detected.

In the same or alternative aspects, the vehicle 1202 can be configured to act as the external device 126 coupled to an electronic device (e.g., another device as described with reference to FIGS. 6-11, 13). For example, the vehicle 1202 can include the speaker 128 to generate the reference sound 124 of FIG. 1, the in-use sounds 138, or some combination thereof.

FIG. 13 depicts an implementation 1300 in which the device 102 includes a portable electronic device that corresponds to an extended reality headset 1302 (e.g., a virtual reality headset, a mixed reality headset, an augmented reality headset, or a combination thereof). The extended reality headset 1302 includes the microphone 107. Components of the processor(s) 104 of FIG. 1, including the echo cancelation controller 112, are integrated in the extended reality headset 1302. In a particular aspect, a visual interface device is positioned in front of the user's eyes to enable display of augmented reality, mixed reality, or virtual reality images or scenes to the user while the extended reality headset 1302 is worn.

In a particular example, the echo cancelation controller 112 operates to select a particular echo delay calculation process from among two or more echo delay calculation processes based at least on whether the reference sound is detected. For example, the microphone 107 may capture speech of a user of the extended reality headset 1302, an external device within, integrated into, or in proximity to the extended reality headset 1302, or some combination thereof. The echo cancelation controller 112 may select a particular echo delay process based at least on whether the reference sound 124 of FIG. 1 is detected.

In the same or alternative aspects, the extended reality headset 1302 can be configured to act as the external device 126 coupled to an electronic device (e.g., another device as described with reference to FIGS. 6-12). For example, the extended reality headset 1302 can include the speaker 128 to generate the reference sound 124 of FIG. 1, the in-use sounds 138, or some combination thereof.

Devices (e.g., those previously mentioned in FIGS. 1-13) may have both Bluetooth and Wi-Fi capabilities, or other wireless means to communicate with each other. Inter-networked devices may have wireless means to communicate with each other and may also be connected based on different cellular communication systems, such as, a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. As used herein, “wireless” refers to one or more of the above-listed technologies, one or more other technologies that enable transfer of information other than via wires, or a combination thereof.

Wireless technologies, such as Bluetooth® (“Bluetooth”) and Wireless Fidelity “Wi-Fi” or variants of Wi-Fi (e.g. Wi-Fi Direct), enable high speed communications between mobile electronic devices (e.g., cellular phones, watches, headphones, remote controls, etc.) that are within relatively short distances of one another (e.g., 100 to 200 meters or less depending on the specific wireless technology). Wi-Fi is often used to connect and exchange information between a device with an access point, (e.g. a router) and devices that are Wi-Fi enabled. Examples of such devices are smart televisions, laptops, thermostats, personal assistant devices, home automation devices, wireless speakers and other similar devices. Similarly, Bluetooth is also used to couple devices together. Example of such are mobile phones, computers, digital cameras, wireless headsets, keyboards, mice or other input peripherals, and similar devices.

In conjunction with the described implementations, an apparatus includes means for detecting a connection to an external device including a speaker. For example, the means for detecting the connection to the external device 126 including the speaker 128 includes the device 102, the processor(s) 104, one or more other circuits or components configured to detect a connection to an external device, or any combination thereof.

The apparatus also includes means for transmitting a signal to the external device, the signal instructing the external device to output a reference sound in an ultrasound frequency range. For example, the means for transmitting the signals 122 to the external device 126, the signals 122 instructing the external device 126 to output the reference sound 124 in an ultrasound frequency range includes the device 102, the processor(s) 104, the processor 406, the processor(s) 404, the modem 140, the modem 412, the transceiver 414, the antenna 416, one or more other circuits or components configured to transmit a signal to the external device, or any combination thereof.

The apparatus also includes means for selecting a particular echo delay calculation process from among two or more echo delay calculation processes based at least on whether the reference sound is detected. For example, the means for selecting the particular echo delay calculation process from among two or more echo delay calculation processes based at least on whether the reference sound 124 is detected includes the device 102, the processor(s) 104, the echo delay calculation process selector 108, one or more other circuits or components configured to select a particular echo delay calculation process, or any combination thereof.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Particular aspects of the disclosure are described below in a first set of interrelated clauses:
According to Clause 1, a device includes one or more processors. The one or more processors are configured to detect a connection to an external device including a speaker. The one or more processors are also configured to transmit a signal to the external device, the signal instructing the external device to output a reference sound in an ultrasound frequency range. The one or more processors are also configured to select a particular echo delay calculation process from among two or more echo delay calculation processes based at least on the reference sound is detected.
Clause 2 includes the device of Clause 1, wherein the device includes a smartphone.
Clause 3 includes the device of Clause 1 or Clause 2, wherein the one or more processors are further configured to receive the reference sound from the external device. The one or more processors are also configured to communicate data associated with the received reference sound to an echo delay controller.
Clause 4 includes the device of Clause 3, wherein a first echo delay calculation process of the two or more echo delay calculation processes includes determining, by the echo delay controller, an echo path delay time for the external device the device to the speaker based at least on the data associated with the received reference sound.
Clause 5 includes the device of Clause 3 or Clause 4, wherein the one or more processors are configured to select a first echo delay calculation process of the two or more echo delay calculation processes responsive to receipt of the reference sound from the external device.
Clause 6 includes the device of any of Clauses 1-5, wherein a second echo delay calculation process of the two or more echo delay calculation processes includes determining, using a trained model, an estimated echo delay time.
Clause 7 includes the device of any of Clauses 1-6, wherein the one or more processors are configured to select a second echo delay calculation process of the two or more echo delay calculation processes responsive to not receiving the reference sound from the external device.
Clause 8 includes the device of any of Clauses 1-7, wherein the one or more processors are further configured to provide an output of a first echo delay calculation process of the two or more echo delay calculation processes, an output of a second echo delay calculation process of the wo or more echo delay calculation processes, or both, as input to an echo cancelation process.
Clause 9 includes the device of any of Clauses 1-8, wherein the ultrasound frequency range is approximately 20-22 kHz.
Clause 10 includes the device of any of Clauses 1-9, wherein the connection includes a high-definition multimedia interface (HDMI) connection.
Clause 11 includes the device of Clause 10, wherein detecting the connection includes detecting that the device has been coupled to the external device via the HDMI connection.
Clause 12 includes the device of any of Clauses 1-11, wherein the connection includes a wireless connection.
According to Clause 13, a method includes automatically detecting, by a device, a connection to an external device including a speaker. The method also includes, responsive to automatically detecting the connection, transmitting, by the device, a signal to the external device, the signal instructing the external device to output a reference sound in an ultrasound frequency range. The method also includes selecting, by the device, a particular echo delay calculation process from among two or more echo delay calculation processes based at least on the reference sound is detected.
Clause 14 includes the method of Clause 13, wherein the device includes a smartphone.
Clause 15 includes the method of Clause 13 or Clause 14, wherein the method further includes receiving the reference sound from the external device. The method also further includes communicating data associated with the received reference sound to an echo delay controller.
Clause 16 includes the method of Clause 15, wherein a first echo delay calculation process of the two or more echo delay calculation processes includes determining, by the echo delay controller, an echo path delay time for the external device based at least on the data associated with the received reference sound.
Clause 17 includes the method of Clause 15 or Clause 16, wherein the method further includes selecting a first echo delay calculation process of the two or more echo delay calculation processes responsive to receipt of the reference sound from the external device.
Clause 18 includes the method of any of Clauses 13-17, wherein a second echo delay calculation process of the two or more echo delay calculation processes includes determining, using a trained model, an estimated echo delay time.
Clause 19 includes the method of any of Clauses 13-18, wherein the method further includes selecting a second echo delay calculation process of the two or more echo delay calculation processes responsive to not receiving the reference sound from the external device.
Clause 20 includes the method of any of Clauses 13-19, wherein the method further includes providing an output of a first echo delay calculation process of the two or more echo delay calculation processes, an output of a second echo delay calculation process of the wo or more echo delay calculation processes, or both, as input to an echo cancelation process.
Clause 21 includes the method of any of Clauses 13-20, wherein the ultrasound frequency range is approximately 20-22 kHz.
Clause 22 includes the method of any of Clauses 13-21, wherein the connection includes a high-definition multimedia interface (HDMI) connection.
Clause 23 includes the method of Clause 22, wherein detecting the connection includes detecting that the method has been coupled to the external device via the HDMI connection.
Clause 24 includes the method of any of Clauses 13-23, wherein the connection includes a wireless connection.
According to Clause 25, a non-transient, computer-readable medium stores instructions that, when executed by a processor, cause the processor to automatically detect, at a device, a connection to an external device including a speaker. The instructions, when executed by the processor, also cause the processor to, responsive to automatically detecting the connection, transmit, by the device, a signal to the external device, the signal instructing the external device to output a reference sound in an ultrasound frequency range. The instructions, when executed by the processor, also cause the processor to, select a particular echo delay calculation process from among two or more echo delay calculation processes based at least on the reference sound is detected.
Clause 26 includes the non-transient, computer-readable medium of Clause 25, wherein the device includes a smartphone.
Clause 27 includes the non-transient, computer-readable medium of Clause 25 or Clause 26, wherein the instructions, when executed by the processor, further cause the processor to: receive the reference sound from the external device; and communicate data associated with the received reference sound to an echo delay controller.
Clause 28 includes the non-transient, computer-readable medium of Clause 27, wherein a first echo delay calculation process of the two or more echo delay calculation processes includes determining, by the echo delay controller, an echo path delay time for the external device based at least on the data associated with the received reference sound.
Clause 29 includes the non-transient, computer-readable medium of Clause 27 or Clause 28, wherein the instructions, when executed by the processor, further cause the processor to select a first echo delay calculation process of the two or more echo delay calculation processes responsive to receipt of the reference sound from the external device.
Clause 30 includes the non-transient, computer-readable medium of any of Clauses 25-29, wherein a second echo delay calculation process of the two or more echo delay calculation processes includes determining, using a trained model, an estimated echo delay time.
Clause 31 includes the non-transient, computer-readable medium of any of Clauses 25-30, wherein the instructions, when executed by the processor, further cause the processor to select a second echo delay calculation process of the two or more echo delay calculation processes responsive to not receiving the reference sound from the external device.
Clause 32 includes the non-transient, computer-readable medium of any of Clauses 25-31, wherein the instructions, when executed by the processor, further cause the processor to provide an output of a first echo delay calculation process of the two or more echo delay calculation processes, an output of a second echo delay calculation process of the wo or more echo delay calculation processes, or both, as input to an echo cancelation process.
Clause 33 includes the non-transient, computer-readable medium of any of Clause 25-32, wherein the ultrasound frequency range is approximately 20-22 kHz.
Clause 34 includes the non-transient, computer-readable medium of any of Clauses 25-33, wherein the connection includes a high-definition multimedia interface (HDMI) connection.
Clause 35 includes the non-transient, computer-readable medium of Clause 34, wherein the instructions, when executed by the processor, cause the processor to detect the connection by detecting that the device has been coupled to the external device via the HDMI connection.
Clause 36 includes the non-transient, computer-readable medium of any of Clauses 25-35, wherein the connection includes a wireless connection.
According to Clause 37, device includes means for detecting a connection to an external device including a speaker. The device also includes means for transmitting a signal to the external device, the signal instructing the external device to output a reference sound in an ultrasound frequency range. The device also includes means for selecting, by the device, a particular echo delay calculation process from among two or more echo delay calculation processes based at least on the reference sound is detected.
Clause 38 includes the device of Clause 37, wherein the device includes a smartphone.
Clause 39 includes the device of Clause 37 or Clause 38, wherein the device further includes means for receiving the reference sound from the external device. The device also includes means for communicating data associated with the received reference sound to an echo delay controller.
Clause 40 includes the device of Clause 39, wherein a first echo delay calculation process of the two or more echo delay calculation processes includes determining, by the echo delay controller an echo path delay time for the external device based at least on the data associated with the received reference sound.
Clause 41 includes the device of Clause 39 or Clause 40, wherein the device further includes means for selecting a first echo delay calculation process of the two or more echo delay calculation processes responsive to receipt of the reference sound from the external device.
Clause 42 includes the device of any of Clauses 37-41, wherein a second echo delay calculation process of the two or more echo delay calculation processes includes determining, using a trained model, an estimated echo delay time.
Clause 43 includes the device of any of Clauses 37-42, wherein the device further includes means selecting a second echo delay calculation process of the two or more echo delay calculation processes responsive to not receiving the reference sound from the external device.
Clause 44 includes the device of any of Clauses 37-43, wherein the device further includes means for providing an output of a first echo delay calculation process of the two or more echo delay calculation processes, an output of a second echo delay calculation process of the wo or more echo delay calculation processes, or both, as input to an echo cancelation process.
Clause 45 includes the device of any of Clauses 37-44, wherein the ultrasound frequency range is approximately 20-22 kHz.
Clause 46 includes the device of any of Clauses 37-45, wherein the connection includes a high-definition multimedia interface (HDMI) connection.
Clause 47 includes the device of Clause 46, wherein the mean for detecting the connection includes means for detecting that the device has been coupled to the external device via the HDMI connection.
Clause 48 includes the device of any of Clauses 37-47, wherein the connection includes a wireless connection.

1. A device comprising:
one or more processors configured to:
detect a connection to an external device comprising a speaker;
transmit a signal to the external device, the signal instructing the external device to output a reference sound in an ultrasound frequency range; and
select a particular echo delay calculation process from among two or more echo delay calculation processes based at least on whether the reference sound is detected.

2. The device of claim 1, wherein the device comprises a smartphone.

3. The device of claim 1, wherein the one or more processors are further configured to:
receive the reference sound from the external device; and
communicate data associated with the received reference sound to an echo delay controller.

4. The device of claim 3, wherein a first echo delay calculation process of the two or more echo delay calculation processes comprises determining, by the echo delay controller, an echo path delay time for the external device based at least on the data associated with the received reference sound.

5. The device of claim 3, wherein the one or more processors are configured to select a first echo delay calculation process of the two or more echo delay calculation processes responsive to receipt of the reference sound from the external device.

6. The device of claim 1, wherein a second echo delay calculation process of the two or more echo delay calculation processes comprises determining, using a trained model, an estimated echo delay time.

7. The device of claim 1, wherein the one or more processors are configured to select a second echo delay calculation process of the two or more echo delay calculation processes responsive to not receiving the reference sound from the external device.

8. The device of claim 1, wherein the one or more processors are further configured to provide an output of a first echo delay calculation process of the two or more echo delay calculation processes, an output of a second echo delay calculation process of the two or more echo delay calculation processes, or both, as input to an echo cancelation process.

9. The device of claim 1, wherein the ultrasound frequency range is approximately 20-22 kHz.

10. The device of claim 1, wherein the connection comprises a high-definition multimedia interface (HDMI) connection.

11. The device of claim 1, wherein the connection comprises a wireless connection.

12. A method comprising:
automatically detecting, by a device, a connection to an external device comprising a speaker;
responsive to automatically detecting the connection, transmitting, by the device, a signal to the external device, the signal instructing the external device to output a reference sound in an ultrasound frequency range; and
selecting, by the device, a particular echo delay calculation process from among two or more echo delay calculation processes based at least on whether the reference sound is detected.

13. The method of claim 12, wherein the method further comprises:
receiving the reference sound from the external device; and
communicating data associated with the received reference sound to an echo delay controller.

14. The method of claim 13, wherein a first echo delay calculation process of the two or more echo delay calculation processes comprises determining, by the echo delay controller, an echo path delay time for the external device based at least on the data associated with the received reference sound.

15. The method of claim 13, wherein the method further comprises selecting a first echo delay calculation process of the two or more echo delay calculation processes responsive to receipt of the reference sound from the external device.

16. The method of claim 12, wherein a second echo delay calculation process of the two or more echo delay calculation processes comprises determining, using a trained model, an estimated echo delay time.

17. The method of claim 12, wherein the method further comprises selecting a second echo delay calculation process of the two or more echo delay calculation processes responsive to not receiving the reference sound from the external device.

18. The method of claim 12, wherein the method further comprises providing an output of a first echo delay calculation process of the two or more echo delay calculation processes, an output of a second echo delay calculation process of the two or more echo delay calculation processes, or both, as input to an echo cancelation process.

19-30. (canceled)
